(19) United States
(12) Patent Application Publication
(10) Pub. No.: US 2018/0303175 A1
(43) Pub. Date: Oct. 25, 2018

(54) APPARATUSES, METHODS AND SYSTEMS FOR PROTECTIVE GLOVES

(71) Applicant: RINGERS TECHNOLOGIES LLC, Houston, TX (US)

(72) Inventor: Hardy LIM, Houston, TX (US)

(73) Assignee: RINGERS TECHNOLOGIES LLC, Houston, TX (US)

(21) Appl. No.: 15/493,925

(22) Filed: Apr. 21, 2017

(51) Int. Cl. A41D 19/015; A41D 19/00; G06F 3/01

(52) U.S. Cl. CPC A41D 19/01529; A41D 19/0048; A41D 2600/20; A41D 19/01505; G06F 3/014; A41D 19/01523

(57) ABSTRACT

A glove protecting a hand of a user while facilitating dexterity in police or military activities, such as firing a gun or operating a touch screen. A flame resistant glove body includes a palm sleeve, a thumb sleeve, a trigger finger sleeve and a plurality of finger sleeves extending distally from the palm sleeve. The trigger finger sleeve has a protective pad extending along a proximal back side thereof, and an unprotected distal portion extending from a distal end of the protective pad to a distal end of the trigger finger sleeve. A conductive tab is positioned on one or more sleeves for use in operating a touch screen while wearing the glove. The conductive tab can be provided on only one sleeve, such as the middle finger sleeve. Flame resistant padding is provided along a back side of the glove.

### BRIEF DESCRIPTION OF THE DRAWINGS

FIG. 1 shows a top view of a back side of a glove, according to an exemplary embodiment of the present disclosure.

FIG. 2 shows a bottom view of a palm side of a glove, according to an exemplary embodiment of the present disclosure.

FIG. 3A shows a side view of a phalangeal segment, according to an exemplary embodiment of the present disclosure.

FIG. 3B shows a section view along 3B-3B of FIG. 3A, featuring internal structures of a distal finger sleeve.

FIG. 3C shows a section view showing an alternative construction of a distal finger sleeve.

FIG. 4 shows a side view of a phalangeal segment, according to an exemplary embodiment of the present disclosure.

FIG. 5 shows a side view of a back side of a thumb sleeve featuring an exemplary embodiment of protective padding.

FIG. 6 shows a side view of a trigger finger sleeve, according to an exemplary embodiment of the present disclosure.

FIG. 7 shows a bottom view of a palm side of a glove, according to an exemplary embodiment of the present disclosure.

FIG. 8 shows a bottom view of a palm side of a glove, featuring a seamless construction of a conductive tab and a loop pad attachment member having an attachment loop thereon.

### DESCRIPTION OF EMBODIMENTS

Like reference characters denote like parts in the drawings.

Touch screen or swipe technology is increasingly used to operate electronic devices, such as smart phones and tablets, in the workplace. Workers in many industries wear protective gloves. For workers who wear gloves while using touch screens, significant amounts of time are wasted repeatedly removing and replacing gloves in order to use touch screens. Additionally, the risk of injury increases when gloves are removed to use a touch screen. These problems have led to the development of gloves that can be worn while operating touch screens.

In police and military work, specialized protective gloves have been developed that allow officers to perform police job functions while minimizing the risk of injury. Police protective gloves feature a balance between protection and dexterity. Features of police protective gloves include the use of flame resistant material to protect from burns, protective padding in selected areas, and reduction of bulk in selected areas to facilitate tasks such as shooting a gun, applying handcuffs, driving, and the like. Up until now, a drawback of specialized police protective gloves has been the inability to use such gloves to operate touch screens while benefiting from the protective benefits and operability of police gloves.

The present invention is a glove 100 that is configured to protect a hand of a user while facilitating dexterity in police or military activities, such as firing a gun or operating a touch screen. In general, the glove includes a flame resistant glove body configured to receive and enclose a hand of a user, the flame resistant glove body including a palm sleeve, a thumb sleeve extending from the palm sleeve, and a trigger finger sleeve and a plurality of finger sleeves extending distally from the palm sleeve. The trigger finger sleeve has a protective pad extending along a proximal back side thereof, and an unprotected distal portion extending from a distal end of the protective pad to a distal end of the trigger finger sleeve to thereby facilitate firing a gun while wearing the glove. A conductive tab is positioned on one of the thumb sleeve, the trigger finger sleeve or plurality of finger sleeves for use in operating a touch screen while wearing the glove. In some embodiments, the conductive tab is on the trigger finger sleeve. In some embodiments, the plurality of finger sleeves includes a middle finger sleeve, and a conductive tab is on the middle finger sleeve. A conductive tab can be provided on the thumb sleeve, the conductive tab positioned for use in operating a touch screen.

In embodiments, flame resistant padding extends along a back side of the palm sleeve, the back side of the thumb sleeve, and the back side of the plurality of finger sleeves, the flame resistant padding sized and positioned to protect a hand of a user. A gauntlet sleeve can be provided, the gauntlet sleeve depending distally from the palm sleeve, and an elastic wrist band can be disposed between the palm sleeve and the gauntlet sleeve. The conductive tab can be polyurethane. The flame resistant glove body can comprise aramid fibers. The protective pad and the padding can comprise thermopoly rubber. In some embodiments, the conductive tab is affixed to the sleeve via a seamless construction.

In embodiments, the glove includes a flame resistant glove body configured to receive and enclose a hand of a user, a palmar side of the glove body comprising flame resistant leather, a back side of the glove body comprising flame resistant fabric, the glove body including a palm sleeve, a thumb sleeve extending from the palm sleeve, and a trigger finger sleeve and a plurality of finger sleeves extending distally from the palm sleeve. The trigger finger sleeve has a protective pad extending along a proximal back side thereof, and an unprotected distal portion extending from a distal end of the protective pad to a distal end of the trigger finger sleeve to thereby facilitate firing a gun while wearing the glove. A conductive tab is conductive tab positioned on one of the thumb sleeve, the trigger finger sleeve or plurality of finger sleeves for use in operating a touch screen while wearing the glove, and is affixed over the flame resistant leather of the palmar side. The conductive tab can be on the trigger finger sleeve. The plurality of finger sleeves can include a middle finger sleeve, and wherein the conductive tab is on the middle finger sleeve. The conductive tab can be on the thumb sleeve, the conductive tab positioned for use in operating a touch screen. Flame resistant padding can extend along a back side of the palm sleeve, the back side of the thumb sleeve, and the back side of the plurality of finger sleeves, the flame resistant padding sized and positioned to protect a hand of a user. A gauntlet sleeve can depend distally from the palm sleeve. An elastic wrist band can be disposed between the palm sleeve and the gauntlet sleeve. The conductive tab can be polyurethane. The flame resistant glove body can comprise aramid fibers. The protective pad and the padding can comprise thermopoly rubber. In some embodiments, the conductive tab is affixed to the sleeve via a seamless construction.

In embodiments, the glove includes a flame resistant glove body configured to receive and enclose a hand of a user, the flame resistant glove body including a palm sleeve, a thumb sleeve extending from the palm sleeve, a trigger finger sleeve and a plurality of finger sleeves extending distally from the palm sleeve, the plurality of finger sleeves including a middle finger sleeve adjacent to the trigger finger sleeve, the trigger finger sleeve having a protective pad extending along a proximal back side thereof, and an unprotected distal portion extending from a distal end of the protective pad to a distal end of the trigger finger sleeve to thereby facilitate firing a gun while wearing the glove. A conductive tab is positioned on the middle finger sleeve for use in operating a touch screen while wearing the glove. The conductive tab can be affixed to the middle finger sleeve via a seamless construction. The seamless construction can include an inside seam situated on an interior of the glove between a lower end of the conductive tab and the flame resistant leather such that there is no exteriorly exposed seam between conductive tab and the flame resistant leather. In embodiments, an interior side of the conductive tab is underlined with the flame resistant leather for protection of a user. In some embodiments, an interior side of the conductive tab is unlined for improved feel through the conductive tab and a fingertip of a user.

A flame resistant padding can extend along a back side of the palm sleeve, the back side of the thumb sleeve, and the back side of the plurality of finger sleeves, the flame resistant padding sized and positioned to protect a hand of a user. A gauntlet sleeve can depend distally from the palm sleeve, and an elastic wrist band can be disposed between the palm sleeve and the gauntlet sleeve. The conductive tab can be polyurethane. The flame resistant glove body can comprise aramid fibers. The protective pad and the padding can comprise thermopoly rubber.

The gloves can be provided as a pair, with a first one of the pair of gloves configured for a right hand and a second one of the pair of gloves is configured for a left hand, such that the pair of gloves is configured for use in firing a gun and operating a touch screen with both a right and a left hand.

The present invention is a glove 100 that is configured to protect a hand of a user while facilitating dexterity in police or military activities, such as firing a gun or operating a touch screen. The glove 100 generally comprises a flame resistant glove body 101 configured to receive and enclose a hand of a user. The flame resistant glove body 101 includes a palm sleeve 103. A thumb sleeve 132 extends from the palm sleeve 103. A trigger finger sleeve 111 and a plurality of finger sleeves 112, 113, 114 extend distally from the palm sleeve 103.

The trigger finger sleeve 111 has a protective pad 120 extending along a proximal back side thereof. The finger sleeve 111 has an unprotected distal portion extending from a distal end of the protective pad 120 to a distal end of the trigger finger sleeve 111. This configuration facilitates firing a gun while wearing the glove 100.

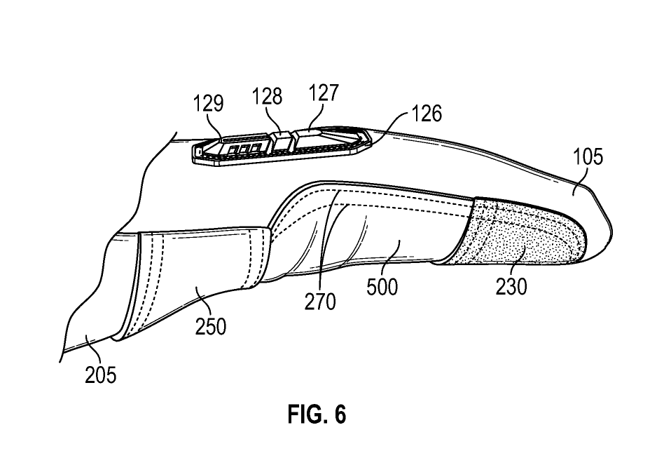

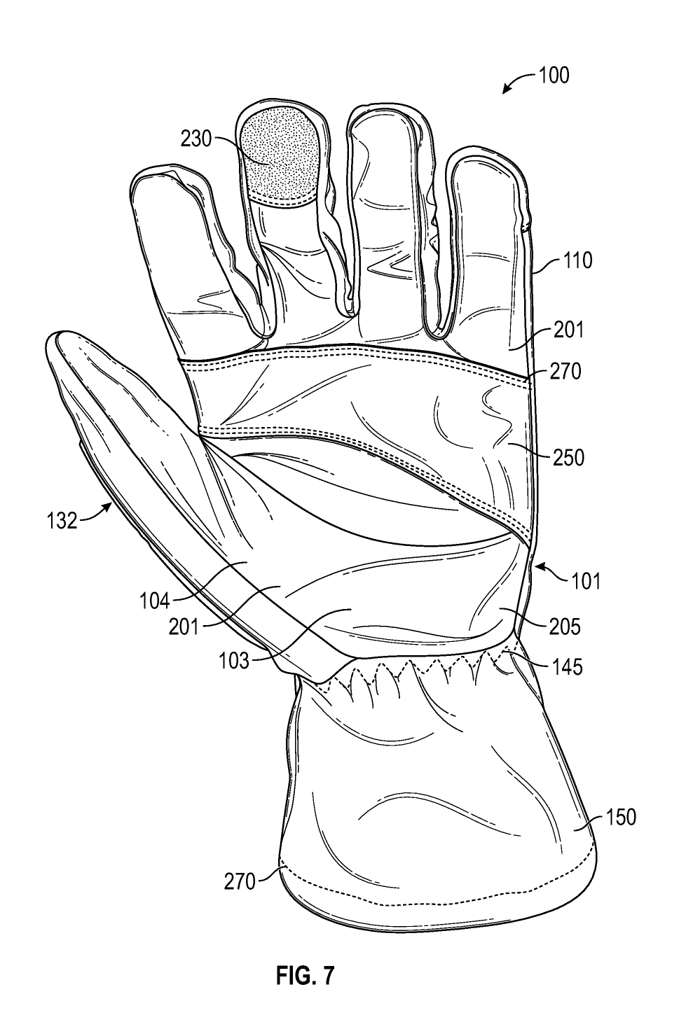

In an alternative embodiment of trigger finger sleeve 111, as shown in FIG. 6, glove bottom 205 may be configured to extend from the palmar surface, around the side of the trigger finger sleeve 111 to form protective member 500. As shown in FIG. 6, protective member 500 extends long the side of the trigger finger sleeve 111 nearest the thumb. Configurations as provided by FIG. 6 may provide law enforcement and military personnel additional protection along trigger finger sleeve 111 during standard activities, such as the use of firearms or other weaponry. A double layer of stitching 270, as shown in FIG. 6, may be included to provide additional reinforcement.

At least one conductive tab 230 is provided for use in operating a touch screen while wearing the glove 100. A conductive tab 230 can be provided on the trigger finger sleeve 111, on the thumb sleeve 132, on a middle finger sleeve 112, or on all of the foregoing sleeves. In another embodiment, as illustrated in FIG. 7, conductive tab 230 may be only on the middle finger. The conductive tabs are positioned for use in operating a touch screen, such as by placement on a palm side of a tip of the sleeves 111, 112, 130.

The glove 100 can be provided with flame resistant padding 115, 140 for additional protection from fire, heat, blows, abrasion and the like. Padding 115, 140 extends along a back side of the palm sleeve 103, the back side of the thumb sleeve 132, and the back side of the plurality of finger sleeves 112, 113, 114. The plurality of finger sleeves may be joined one to the other and to the glove back 105 and glove bottom 205 by an interdigital section 700 of material, e.g., leather. The flame resistant padding 115, 140 is sized and positioned to protect the hand of a user.

The glove 100 can be provided with a gauntlet sleeve 150 for additional protection. The gauntlet sleeve 150 depends distally from the palm sleeve 103. An elastic wrist band 145 can be disposed between the palm sleeve 103 and the gauntlet sleeve 150.

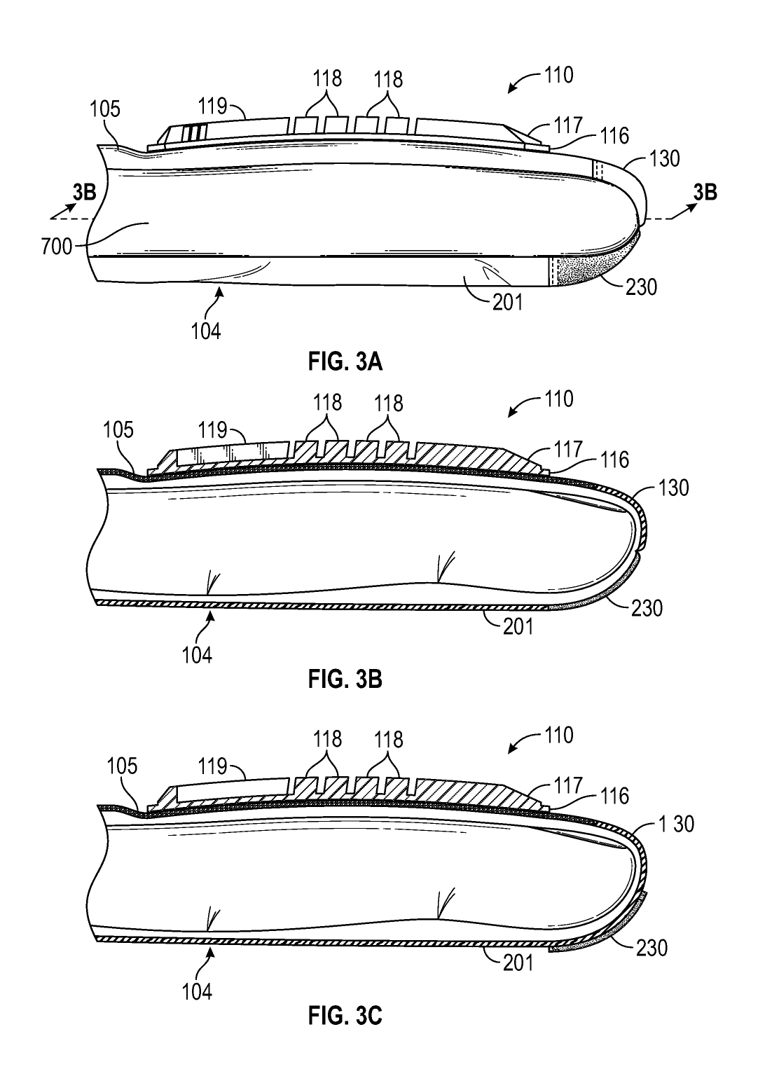

In one construction, a palmar side 104 of the glove body 101 comprises flame resistant leather, while a back side 105 of the glove body 101 comprises a flame resistant fabric 202. As shown in FIG. 3C, the conductive tab 230 can be affixed over the flame resistant leather 201 of the palmar side 104, yet still operate a touch pad through the leather 201.

The conductive tab 230 comprises a material that conducts charge from a user to a touch screen, such as polyurethane. The flame resistant fabric 202 can comprise aramid fibers, such as KEVLAR® fibers. The protective pad 120 and the padding 110, 140 can comprise thermopoly rubber.

The gloves 100 can be provided as a pair having a right hand and a left hand glove 100, such that the pair of gloves is configured for use in firing a gun and operating a touch screen with both a right and a left hand.

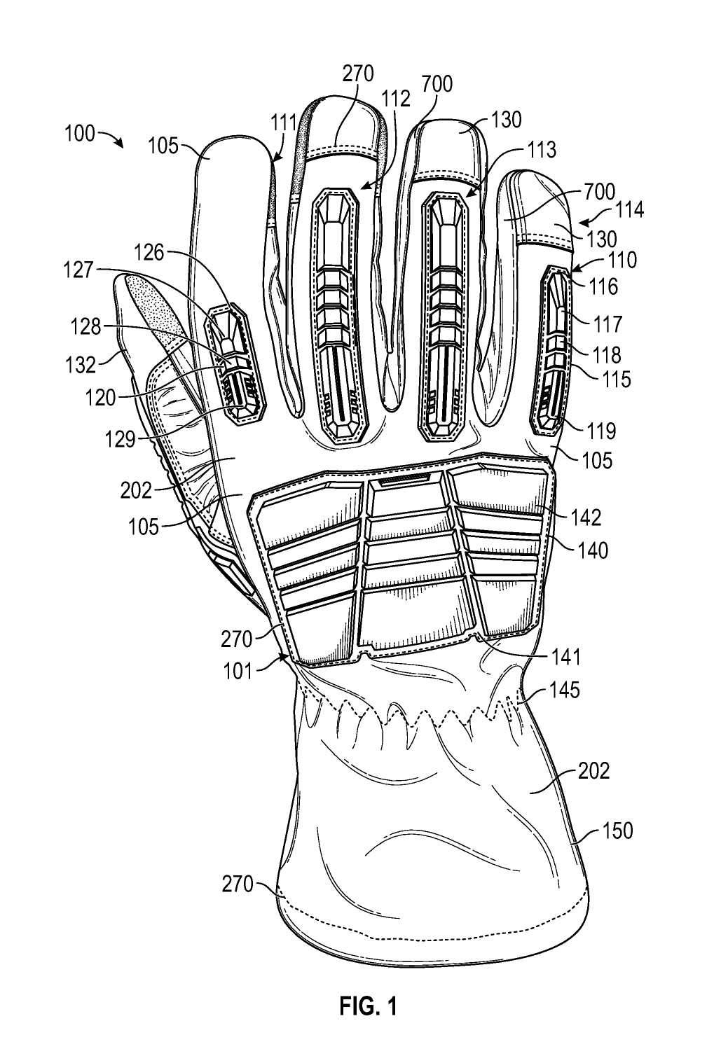

Details of the drawings will now be described. FIG. 1 shows a back or dorsal view of an embodiment of a protective glove 100. The glove 100 has a flame resistant glove body 101 configured to receive and enclose a hand of a user. A back side 105 of the glove is made of a durable, flexible, flame resistant material, such as aramid (available commercially as KEVLAR® fabric).

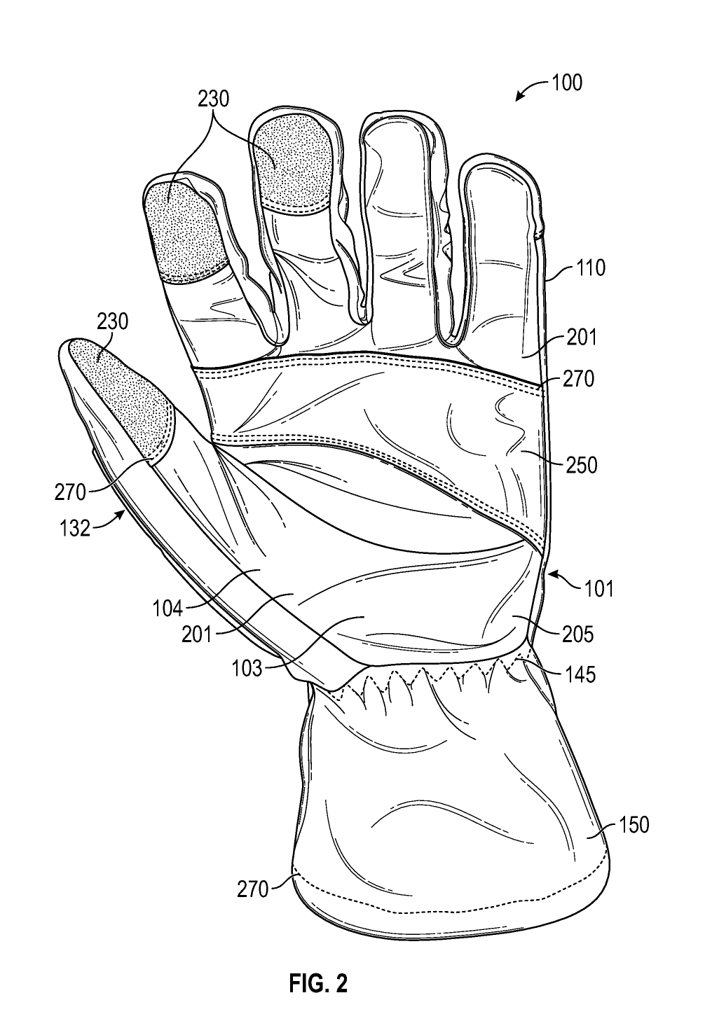

FIG. 2 shows a front or palmar view of an embodiment of a protective glove 100. A palmar side 104 of the glove can be made of a durable, flexible, flame resistant material, such as flame resistant (treated) leather 201. The leather 201 may be goat leather.

The glove body 101 includes a palm sleeve 103 configured to receive and protect a palm area of a user. A thumb sleeve 132 extends from the palm sleeve 103, generally along a medial and palmar side of the glove body 101. The thumb sleeve 132 is configured to receive and protect a thumb of a user. FIG. 5 shows a top view of the thumb sleeve 132 is configured to include protective members 180 and 195. A thumb protective member 180 may include protective members covering both the thumb phalange and thumb metacarpal of a user. FIG. 5 illustrates an embodiment in which a thumb protective member 180 includes a thumb base member 181, a distal phalangeal protective member 182, a plurality of medial phalangeal protective members 183, a proximal phalangeal protective member 184 and a plurality of metacarpal protective members 190. In addition, as shown in FIG. 5, a thumb metacarpal protective member 195 may also be included between thumb protective member 180 and the palm sleeve 103 in order to provide additional protection to the hand of the user.

As shown in FIG. 1, a plurality of individual phalangeal or finger segments 110 extend distally from the palm sleeve 103. The finger segments 110 include a trigger finger sleeve 111 and a plurality of finger sleeves 112, 113, 114. The plurality of finger sleeves can include a middle finger sleeve 112, a ring finger sleeve 113 and a pinky finger sleeve 114. It will be appreciated that some or all of the plurality of finger sleeves 112, 113, 114 can be joined together into a single sleeve, in the manner of a mitten.

A feature of the glove 100 is the ability to operate a touch screen while wearing the glove 100. As shown in FIGS. 2-4, this functionality can be provided by providing at least one conductive tab 230. A conductive tab 230 can be provided on the trigger finger sleeve 111, on the thumb sleeve 132, on a middle finger sleeve 112, or on all of the foregoing sleeves. As shown in FIG. 2, the conductive tabs are positioned for use in operating a touch screen, such as by placement on a palm side of a tip of the sleeves 111, 112, 130.

As shown in FIG. 7, in some embodiments, the conductive tab 230 can be provided on only one of the finger sleeves, such as on only the middle finger sleeve 112. Police, military and other users of glove 100 embodiment depicted in FIG. 7 can manipulate touch screens using the tip of the middle finger. At the same time, by not providing conductive tab 230 touchscreen material on the index fingertip and thumb tip, users of the gloves 100 have better tactile feel and dexterity in the thumb and index finger for use and manipulation of weapons, triggers, switches, levers, and so forth. Thus, multitasking is further facilitated by the embodiment of FIG. 7, while still providing the protective features described herein.

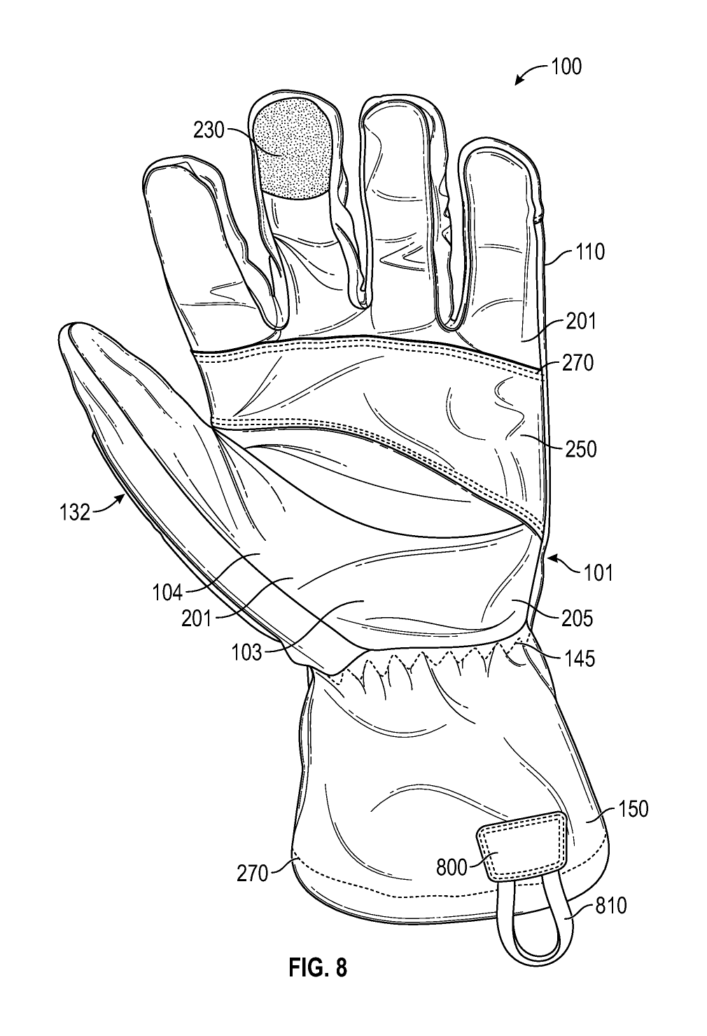

FIG. 8 shows an alternative single conductive tab 230 embodiment featuring a seamless construction of the touch screen material 230. In the embodiment of FIG. 8, inside seam construction has been used to sew the touchscreen material 230 to the tip of middle finger sleeve 112. The stitching between the conductive tab 230 and the flame resistant leather 201 material is located on the interior or inside of glove 100. The interior stitching includes an inside seam situated on an interior of the glove 100 between a lower end of the conductive tab 230 and the flame resistant leather 201 such that there is no exteriorly exposed seam between conductive tab 230 and the flame resistant leather 201. A seamless conductive tab 230 can be used on any of the finger sleeves 111, 112, 113, 114 or thumb sleeve 132. Further, flame resistant leather 201 can be provided under the interior side of conductive tab 230, as indicated in the embodiment of FIG. 3C, for protection. Alternatively, no leather can be provided on the interior side of the conductive tab 230, as indicated in the embodiment of FIG. 3B, for better feel through the conductive tab 230 and finger tip.

Also shown in an alternative embodiment of FIG. 8 is a loop-pad attachment member 800 featuring an attachment loop 810 affixed thereto. The loop-pad 800 can be affixed to the palmer side 103 of the gauntlet cuff 150, as shown in FIG. 8, or to other locations on the glove body 101, such as by stitching. The attachment loop 810 extends from the glove 100 so as to provide an efficient storage option when a user removes the glove 100. The user can readily attach the glove 100 via the attachment loop 810 structure to other structures such as clothing and equipment. For example, the attachment loop 810 can be selectively attached to a utility belt, to gear or structures worn on the user's person, to motorcycle handle bars, or to structures in a squad car, thereby temporarily securing the glove or pair of gloves 100 in a handy and readily accessible location for use.

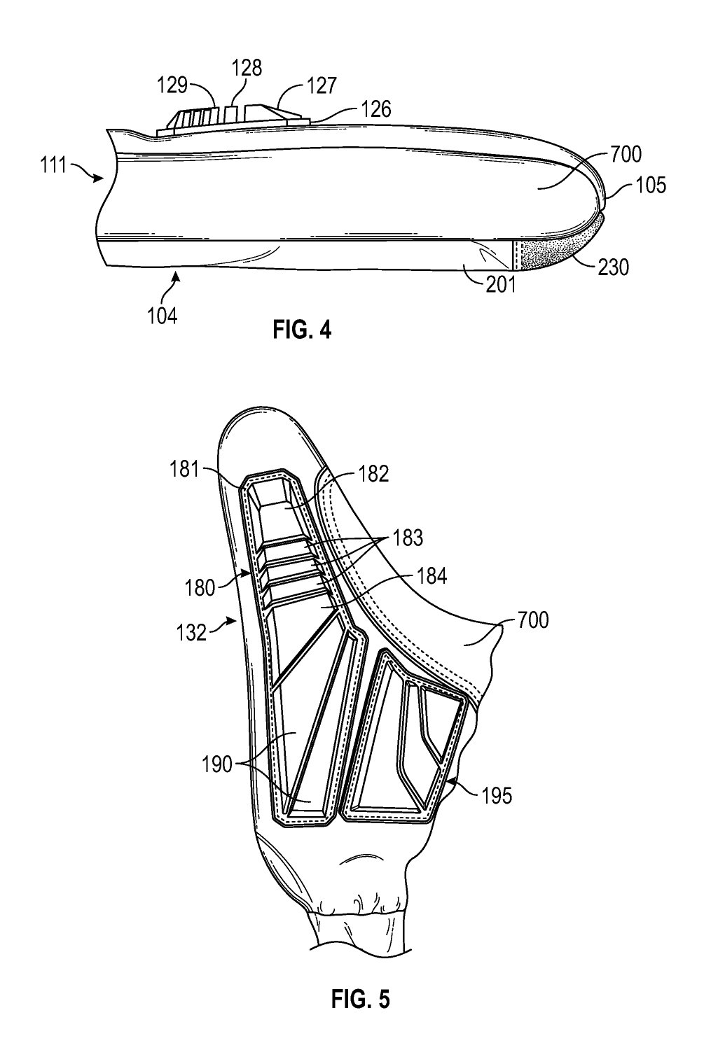

In an embodiment shown in FIGS. 1, 2, 3B and 4, a feature of the glove 100 is a trigger finger sleeve 111 that is configured for use both in operating a touch screen or firing a gun while wearing the glove 100. A distal palmer side of the trigger finger 111 is provided with a distal conductive tab 230 for use in operating a touch screen. Additionally, as shown in FIG. 4, the ability to effectively fire a gun is provided by having a truncated phalangeal protective member or protective pad 120, such that a distal portion of the trigger finger 111 is unimpeded by a protective pad 120. In the embodiment of FIGS. 1 and 4, the trigger finger sleeve 111 has a protective pad 120 extending along a proximal back side thereof. The finger sleeve 111 has an unprotected distal portion extending from a distal end of the protective pad 120 to a distal end of the trigger finger sleeve 111. This configuration facilitates firing a gun while wearing the glove 100. In the embodiment of FIG. 4, the protective pad 120 includes a base member 126. The base member 126 is affixed to a proximal back portion of the trigger finger 111, such as by stitching 270. A plurality of elevated padding members extend from the base member 126, such as a distal elevated padding member 127, at least one medial elevated padding member 128, and a proximal elevated padding member 129. Grooves between some or all of the padding members 127, 128, 129 allow for flexible movement of the trigger finger sleeve 111. The size and position of the truncated protective member 120 allows for unimpeded use of the phalange in space restricted areas, such as the space between a weapon trigger and the trigger guard.

As shown in FIG. 1, the glove 100 can be provided with flame resistant padding 115, 140 for additional protection from fire, heat, blows, abrasion and the like. In the embodiment shown in FIG. 1, the padding 115, 140 extends along a back side of the palm sleeve 103, the back side of the thumb sleeve 132, and the back side of the plurality of finger sleeves 112, 113, 114. The flame resistant padding 115, 140 is sized and positioned to protect the hand of a user. Details of particular embodiments of padding will now be described.

In an embodiment shown in FIGS. 1 and 3, the phalangeal protective member 115 includes a base member 116 along a lower side thereof. The base member 116 is affixed to the glove body 101, such as by stitching 270. A plurality of elevated padding members 117, 118, 119 extend from the base member 116. As seen most clearly in FIGS. 3A and B, the elevated members can include a distal elevated padding member 117, a medial, elevated padding member 118, and a proximal elevated padding member 119.

As shown in FIG. 1, embodiments of the glove 100 may include a metacarpal protective member 140 positioned to protect that back of a hand of a user. In the embodiment of FIG. 1, the metacarpal protective member 140 includes a metacarpal base member 141 along a lower side thereof. The base member 141 is affixed to the glove body 101, such as by stitching 270. Metacarpal base member 141 may extend across the metacarpal region of the hand, covering the region spanning metacarpals two through five. In certain embodiments, metacarpal protective member 140 may include one or more metacarpal elevated padded members 142 extending from the base member 141. In the embodiment of FIG. 1, the protective member 140 may include a plurality of metacarpal elevated padded members 142, the metacarpal elevated padded members 142 separated from one another by grooves in order to improve mobility and flexibility of metacarpal protective member 140. Alternatively, the metacarpal protective member 140 can be provided as a plurality of smaller protective members that are separately affixed to the glove body 101. Embodiments of the various protective members 115, 120, 140 may be flame resistant and may be solid, hollow, air or gas-filled, or include additional material, such as impact resistant material or anti-vibrational material.

As shown in FIG. 1, the individual phalangeal segments 110 may include one or more distal-tip phalangeal protective members 130 on the back side of the fingers of the glove 100. In the embodiment of FIG. 1, the distal-tip phylangeal protective members 130 are provided on the middle, ring and pinky fingers 112, 113, 114. The protective members may be reinforced with bonding material or stitching 270 to strengthen attachment.

As shown in FIGS. 1-2, embodiments of the glove 100 may include gauntlet cuff 150 extending from a distal end of the palm sleeve 103. Moreover, in certain embodiments, gauntlet cuff 150 may include an elastic band 145 circumnavigating the wrist. The elastic band 145 secures the glove body 101 to the hand and restricts entry of unwanted environmental contaminates such as dust, dirt and water by restricting or closing off access to the inside of the glove 100.

As shown in FIG. 2, embodiments of glove 100 may include at least one ventral or palmar protective member 250 on the palm sleeve 103. The palmar protective member 250 provides durability by resisting abrasion, and also provides a better grip on devices such as pistol handles. The palmar protective member 250 may traverse the ventral portion of the palm sleeve 103. The palmar protective member 250 may be formed from a variety of durable, flexible materials. The palmer protective member 250 may be formed from leather, such as goat-leather, and may be flame resistant.

The various components that form the glove 100 may be joined together to form a single unit, for example, by a bonding material. Bonding material may include natural or synthetic material. Bonding material may include glue, adhesive, or stitching. FIGS. 1 and 2 disclose an embodiment of a glove 100 in which various features are joined together by stitching two or more pieces together with stitches 270. Material used for stitching 270 may be natural or synthetic. In certain embodiments, natural materials may include at least one naturally derived fiber or cat-gut. In certain embodiments, synthetic materials for stitching 270 may include synthetic polymers, e.g., nylon or nylon-like polymers. In certain embodiments, synthetic materials for stitching 270 may include aromatic polyamide. Non-limiting examples of aromatic polyamides suitable for stitching 270 may include may include aramid or para-aramid.

In the foregoing, example embodiments are described. It will however be evident that various modifications and changes may be made thereunto without departing from the broader spirit and scope hereof. The specification and drawings are accordingly to be regarded in an illustrative rather than in a restrictive sense.

What is claimed is:

1. A glove configured to protect a hand of a user while facilitating dexterity in police or military activities, such as firing a gun or operating a touch screen, comprising:
a flame resistant glove body configured to receive and enclose a hand of a user, the flame resistant glove body including
a palm sleeve,
a thumb sleeve extending from the palm sleeve,
a trigger finger sleeve and a plurality of finger sleeves extending distally from the palm sleeve,
the trigger finger sleeve having a protective pad extending along a proximal back side thereof, and an unprotected distal portion extending from a distal end of the protective pad to a distal end of the trigger finger sleeve to thereby facilitate firing a gun while wearing the glove, and
a conductive tab, the conductive tab positioned on one of the thumb sleeve, the trigger finger sleeve or plurality of finger sleeves for use in operating a touch screen while wearing the glove.

2. The glove of claim 1, wherein the conductive tab is on the trigger finger sleeve.

3. The glove of claim 1, wherein the plurality of finger sleeves includes a middle finger sleeve, and wherein the conductive tab is on the middle finger sleeve.

4. The glove of claim 2, further comprising a conductive tab on the thumb sleeve, the conductive tab positioned for use in operating a touch screen.

5. The glove of claim 4, wherein the plurality of finger sleeves includes a middle finger sleeve, and further comprising a conductive tab on the middle finger sleeve, the conductive tab positioned for use in operating a touch screen.

6. The glove of claim 5, further comprising flame resistant padding extending along a back side of the palm sleeve, the back side of the thumb sleeve, and the back side of the plurality of finger sleeves, the flame resistant padding sized and positioned to protect a hand of a user.

7. The glove of claim 6, further comprising a gauntlet sleeve depending distally from the palm sleeve, and an elastic wrist band disposed between the palm sleeve and the gauntlet sleeve.

8. The glove of claim 1, wherein the conductive tab is polyurethane.

9. The glove of claim 1, wherein the flame resistant glove body comprises aramid fibers.

10. The glove of claim 6, wherein the protective pad and the padding comprise thermopoly rubber.

11. The glove of claim 1, wherein the conductive tab is affixed to the sleeve via a seamless construction.

12. A pair of gloves according to claim 1, wherein a first one of the pair of gloves is configured for a right hand and a second one of the pair of gloves is configured for a left hand, such that the pair of gloves is configured for use in firing a gun and operating a touch screen with both a right and a left hand.

13. A glove configured to protect a hand of a user while facilitating dexterity in police or military activities, such as firing a gun or operating a touch screen, comprising:
a flame resistant glove body configured to receive and enclose a hand of a user, a palmar side of the glove body comprising flame resistant leather, a back side of the glove body comprising flame resistant fabric, the glove body including
a palm sleeve,
a thumb sleeve extending from the palm sleeve,
a trigger finger sleeve and a plurality of finger sleeves extending distally from the palm sleeve,
the trigger finger sleeve having a protective pad extending along a proximal back side thereof, and an unprotected distal portion extending from a distal end of the protective pad to a distal end of the trigger finger sleeve to thereby facilitate firing a gun while wearing the glove, and
a conductive tab, the conductive tab positioned on one of the thumb sleeve, the trigger finger sleeve or plurality of finger sleeves for use in operating a touch screen while wearing the glove, and
the conductive tab affixed over the flame resistant leather of the palmar side.

14. The glove of claim 13, wherein the conductive tab is on the trigger finger sleeve.

15. The glove of claim 13, wherein the plurality of finger sleeves includes a middle finger sleeve, and wherein the conductive tab is on the middle finger sleeve.

16. The glove of claim 14, further comprising a conductive tab on the thumb sleeve, the conductive tab positioned for use in operating a touch screen.

17. The glove of claim 16, wherein the plurality of finger sleeves includes a middle finger sleeve, and further comprising a conductive tab on the middle finger sleeve, the conductive tab positioned for use in operating a touch screen.

18. The glove of claim 17, further comprising flame resistant padding extending along a back side of the palm sleeve, the back side of the thumb sleeve, and the back side of the plurality of finger sleeves, the flame resistant padding sized and positioned to protect a hand of a user.

19. The glove of claim 18, further comprising a gauntlet sleeve depending distally from the palm sleeve, and an elastic wrist band disposed between the palm sleeve and the gauntlet sleeve.

20. The glove of claim 13, wherein the conductive tab is polyurethane.

21. The glove of claim 13, wherein the flame resistant fabric comprises aramid fibers.

22. The glove of claim 18, wherein the protective pad and the padding comprise thermopoly rubber.

23. The glove of claim 13, wherein the conductive tab is affixed to the sleeve via a seamless construction.

24. A pair of gloves according to claim 13, wherein a first one of the pair of gloves is configured for a right hand and a second one of the pair of gloves is configured for a left hand, such that the pair of gloves is configured for use in firing a gun and operating a touch screen with both a right and a left hand.

25. A glove configured to protect a hand of a user while facilitating dexterity in police or military activities, such as firing a gun or operating a touch screen, comprising:
a flame resistant glove body configured to receive and enclose a hand of a user, a palmar side of the glove body comprising flame resistant leather, a back side of the glove body comprising flame resistant fabric, the glove body including
a palm sleeve,
a thumb sleeve extending from the palm sleeve,
a trigger finger sleeve and a plurality of finger sleeves extending distally from the palm sleeve, the plurality of finger sleeves including a middle finger sleeve adjacent to the trigger finger sleeve,
the trigger finger sleeve having a protective pad extending along a proximal back side thereof, and an unprotected distal portion extending from a distal end of the protective pad to a distal end of the trigger finger sleeve to thereby facilitate firing a gun while wearing the glove, and
a conductive tab, the conductive tab positioned on the middle finger sleeve for use in operating a touch screen while wearing the glove.

26. The glove of claim 25, wherein the conductive tab is affixed to the middle finger sleeve via a seamless construction.

27. The glove of claim 26, wherein the seamless construction includes an inside seam situated on an interior of the glove between a lower end of the conductive tab and the flame resistant leather such that there is no exteriorly exposed seam between conductive tab and the flame resistant leather.

28. The glove of claim 27, wherein an interior side of the conductive tab is underlined with the flame resistant leather for protection of a user.

29. The glove of claim 27, wherein an interior side of the conductive tab is unlined for improved feel through the conductive tab and a fingertip of a user.

30. The glove of claim 25, further comprising flame resistant padding extending along a back side of the palm sleeve, the back side of the thumb sleeve, and the back side of the plurality of finger sleeves, the flame resistant padding sized and positioned to protect a hand of a user.

31. The glove of claim 30, further comprising a gauntlet sleeve depending distally from the palm sleeve, and an elastic wrist band disposed between the palm sleeve and the gauntlet sleeve.

32. The glove of claim 25, wherein the conductive tab is polyurethane.

33. The glove of claim 25, wherein the flame resistant glove body comprises aramid fibers.

34. The glove of claim 30, wherein the protective pad and the padding comprise thermopoly rubber.

35. The glove of claim 25, further comprising a conductive tab on the trigger finger sleeve.

36. The glove of claim 25, further comprising a conductive tab on the thumb sleeve, the conductive tab positioned for use in operating a touch screen.

37. A pair of gloves according to claim 25, wherein a first one of the pair of gloves is configured for a right hand and a second one of the pair of gloves is configured for a left hand, such that the pair of gloves is configured for use in firing a gun and operating a touch screen with both a right and a left hand.
